(19) United States
(12) Patent Application Publication
(10) Pub. No.: US 2003/0140118 A1
(43) Pub. Date: Jul. 24, 2003

(54) Apparatus and method for focused presentations of static and dynamic data using local storage media and networked web pages

(76) Inventors: Ian George Alexander Lloyd, Lonetree, CO (US); Chris Brammer, Lakewood, CO (US); Joel A. Horn, Broomfield, CO (US); Theron J. Rubley, Highlands Ranch, CO (US); Rhonda Bower, Littleton, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(21) Appl. No.: 10/159,477

(22) Filed: May 30, 2002

Related U.S. Application Data
(60) Provisional application No. 60/295,213, filed on Jun. 1, 2001.

(51) Int. Cl. G06F 15/16

(52) U.S. Cl. 709/218

(57) ABSTRACT

An apparatus and method for focused presentations of static and dynamic data using local storage media and networked web pages. In one example of the invention, a focused presentation is encoded on the local storage media, such as a CDROM. The focused presentation provided links to information related to the focus of the presentation. The focused presentation may also include links to a jump stations, which connects the user with a focused network location related to the presentation. The focused network location, such as a website, in one example is accessed through a limited functionality browser window. In one example, a generator module is provided that allows a user to customize one or more presentations.

### CROSS-REFERENCE TO RELATED APPLICATION

This application is related to and claims the benefit of provisional patent application No. 60/295,213 entitled “System And Method For Focused Presentations Of Static And Dynamic Data Using Local Storage Media and Networked Web Pages” filed on Jun. 1, 2001, which is hereby incorporated by reference in its entirety.

### FIELD OF THE INVENTION

This invention relates generally to the presentation of data to a user, and more particularly, to the focused presentation of static and dynamic data on web pages and to the generation of a focused presentation.

### BACKGROUND OF THE INVENTION

The Internet provides an enormous amount of information relating to millions of different topics. Websites on the Internet typically provide an organized collection of information relating to various topics. Oftentimes, however, conventional websites are not limited to very specific information. In this sense, conventional websites may be difficult to navigate due to the large amount of information provided on various different pages of the website. Further, as a user navigates within a website, typically there are a variety of distractions or links to other websites which the user may follow but which do not lead to the ultimate information which the user seeks.

For instance, FIG. 1 shows an example of a conventional website having, within the web page, links to various and numerous unrelated pages, which although these pages are generally organized by general topic headings, a user seeking a specific piece of information or a specific web page within the website would be required often to navigate through a variety of web pages to ultimately reach the desired web page. Further, the conventional website of FIG. 1 also has a search capability which links the user to other websites, as well as banner advertisements which also link the user to other websites. The browser program shown displaying the website is a conventional browser which has browser buttons such as forward and back, and a user-selectable URL entry box. These capabilities further provide a user with the ability to navigate through the various pages and the various websites of the Internet.

With such conventional web page organizations having web pages with links to various different websites, the present inventors have recognized that it is often difficult to provide a user with a focused presentation of data on the Internet. For example, as recognized by the present inventors, where a company has a large website, such as a large computer networking company or a large parts supplier, it may be difficult for a customer or an employee of the company to easily and quickly navigate to desired information. For instance, if the user is seeking service information relating to a particular product, the user conceivably may have to navigate through numerous, different web pages to find the desired information relating to the particular part. In another example, as recognized by the present inventors, if a real estate agent provided a potential client with a website of various home listings, it is conceivable that because of the various links and accessibility to other web pages of other real estate agents, the marketing efforts of the real estate agent may be diluted if the potential client accesses the web pages of other real estate agents and engages the services of another real estate agent.

Data accessing devices, such as CDROM drives, are fairly standard equipment on personal computers and these data accessing devices typically have the ability to quickly read large amounts of data, such as from a CDROM, at very fast access rates—without the need for accessing a network such as the Internet. However, data provided using a CDROM drive and a CDROM disk does not conventionally provide dynamic data to the user, as the data on the CDROM is static data which has been pre-programmed.

As recognized by the present inventors, what is needed is a system and method for providing focused presentations of both static and dynamic data using local storage media and network web pages such that a user is directed toward specific web pages launched from the local storage media. What is also needed is a system and method of conveniently customizing such present actions, and thereby avoiding the necessity of having to create a unique presentation from the ground up for each user.

It is against this background that various embodiments of the present invention were developed and the features, utilities and advantages of the various embodiments of the invention will be apparent from the following more particular description of a preferred embodiment of the invention as illustrated in the accompanying drawings.

### SUMMARY OF THE INVENTION

One embodiment of the invention involves a method for directing a user to a focused network location. The method comprises the operation of providing a presentation encoded on a local storage media. The presentation includes at least one link to at least one focused network location. The method further comprises the operations of receiving a selection of the at least one link to the at least one focused network location; opening a limited access browser window; establishing a connection with the at least one focused network location; and displaying the at least one focused network location within the limited browser access window.

In one example of the method, the at least one link to a focused network location comprises a jump station link to a jump station. In such an example, the method further comprises the operations of receiving a selection of the jump station link; accessing the jump station; receiving an identification associated with the user; and establishing a connection to the focused network location as a function of the identification associated with the user.

The method may further comprise the operations of accessing a database comprising at least one user authentication entry; comparing the at least one user authentication entry with the identification associated with the user; and establishing a connection with the focused network location as a function of the operation of comparing. The database, in one example, comprises at least one focused network location pointer associated with each at least one user authentication entry. In such an example, the method further comprises the operations of determining the at least one focused network location pointer associated with the at least one user authentication entry as a function of the operation of comparing; and establishing a connection with the at least one focused network location associated with the least one focused network location pointer.

Another embodiment of the invention involves a method of providing focused information to a user. The method comprises the operation of providing a presentation encoded on a local storage media. In this embodiment, the presentation includes at least one static information field and at least one dynamic information field. The method further comprises the operations of accessing a site on a network comprising update information for the dynamic information field; receiving the update information for the dynamic information field; and updating the dynamic data information field with the update information.

Another example of the invention involves a method for generating a presentation. The method comprises the operations of providing at least one presentation template comprising at least one dynamic data parameter; providing a generator module comprising at least one entry field corresponding with the at least one dynamic data parameter; receiving an input for the at least one entry field; establishing a connection between the presentation template and the generator module; and modifying the at least one dynamic data field as a function of the operation of receiving an input for the at least one entry field. The method may further comprise, after the operation of modifying the at least one dynamic data field, the operation of encoding the presentation template on a local storage media.

Presentations or presentation templates according to the present invention may comprise information formats selected from the group consisting of text, graphics, images, video, audio, and links. Any method conforming to the present invention may be encoded on a computer-readable medium containing instructions which, when executed, perform the associated methods.

Another embodiment of the present invention involves an apparatus for providing focused information to a user. The apparatus comprises means for storing a presentation; means for linking to a focused network location; means for providing a limited access browser window; means for establishing a connection to the focused network location; and means for displaying the focused network location within the limited access browser window.

### BRIEF DESCRIPTION OF THE DRAWINGS

FIG. 1 illustrates an example of a conventional web page operating within a browser having various controls and buttons available to the user.

FIG. 2 illustrates a block diagram of one embodiment of the present invention.

FIG. 3 illustrates a block diagram of a front-end presentation, a jump station, and a focused website operating within a limited access browser, in accordance with one embodiment of the present invention.

FIG. 4A illustrates the logical operations for preparing a storage media with a presentation and a link to a jump station, and encoding them on a storage media, in accordance with one embodiment of the present invention.

FIG. 4B illustrates the logical operations for creating a presentation, a jump station, and an authentication scheme to be encoded on a storage media, in accordance with one embodiment of the present invention.

FIG. 5 illustrates the logical operations performed by one example of a jump station, in accordance with one embodiment of the present invention.

FIG. 6 illustrates the logical operations for creating a focused web page, in accordance with one embodiment of the present invention.

FIG. 7 illustrates an example of a database, in accordance with one embodiment of the present invention.

FIG. 8A illustrates the logical operations for linking from a presentation to a focused website within a limited access browser, in accordance with one embodiment of the present invention.

FIG. 8B further illustrates the logical operations for linking from a presentation to a focused website within a limited access browser, in accordance with one embodiment of the present invention.

FIG. 9 illustrates an example of the layout of one example of a presentation including various links to jump stations for accessing focused web pages within a limited access browser, in accordance with one embodiment of the present invention.

FIG. 10 illustrates an example display screen showing a top-level page of a presentation, in accordance with one embodiment of the present invention.

FIG. 11 illustrates an example display screen showing an “Application” link which is configured as a link to a jump station shown in FIG. 12, in accordance with one embodiment of the present invention.

FIG. 12 illustrates an example display screen of an authentication page of a jump station operating within a limited access browser, in accordance with one embodiment of the present invention.

FIG. 13 illustrates an example display screen showing a focused web page within a limited access browser window, in accordance with one embodiment of the present invention.

FIG. 14 illustrates one example of a Macromedia Director™ program for creating a presentation.

FIG. 15 illustrates a block diagram of a background process for providing a presentation with updated dynamic data, in accordance with one embodiment of the present invention.

FIG. 16 illustrates the logical operations for updating a variable display item of a presentation, in accordance with one embodiment of the present invention.

FIG. 17 illustrates an example display screen of a presentation having a variable display item, static data, and dynamic data, in accordance with one embodiment of the present invention.

FIG. 18 illustrates an example display screen of the presentation program of FIG. 17, wherein the variable display item has been updated, in accordance with one embodiment of the present invention.

FIG. 19 illustrates the logical operations for generating a presentation, in accordance with one embodiment of the invention.

FIG. 20 illustrates a block diagram of a presentation generator, in accordance with one embodiment of the present invention.

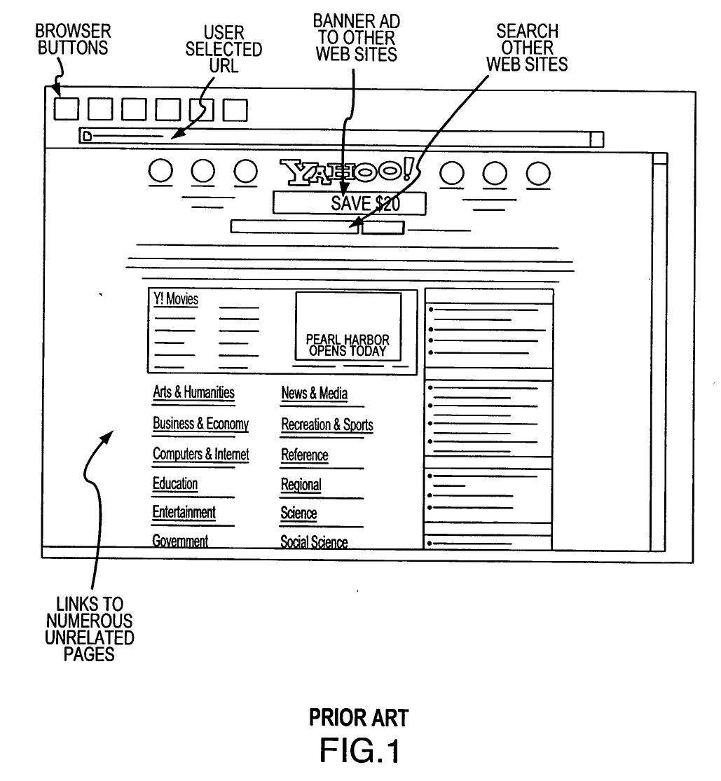

### DETAILED DESCRIPTION OF THE INVENTION

In accordance with various embodiments of the present invention, an apparatus and method is provided for focused presentations of static and dynamic data using local storage media and network web pages. In this manner, embodiments of the present invention permit customized data to be presented to a user from a storage media, such as a local CDROM disk having a presentation thereon, which provides a link to both static and dynamic data on a focused website, using in one example, a limited access browser. Accordingly, the user is directed to information while not being subjected to various distractions of other links, extraneous banner ads, or other unrelated information. Embodiments of the present invention therefore permit a content provider to provide focused contents to a user, provide the rapid speed of access of local storage media, such as a CDROM disk and drive, and also provide the dynamic data capabilities of a website.

As used herein, the term “focused website” includes, but is not limited to, a website that contains specific data elements and links which are intended to be accessible by one or more designated or selected users, while excluding extraneous, irrelevant, or other immaterial data or links. For instance, a focused website could include a web page that contains particularized data for presentation to a user, while excluding any banner ads or links to unrelated or undesirable websites. In one example, the focused website is capable of displaying both static data which is unchanged over periods of time, and dynamic data which may change or vary as time varies (e.g., the temperature in Denver, Colo., the rate for a 30 year conventional mortgage, etc.).

As used herein, the term “limited access browser” includes, but is not limited to, a browser that limits the access of a user to less than the entire network of network sites, such as websites. In one example, the limited access browser has less than the full capability of user controls. In another example, the limited access browser has one or more of the following controls disabled at any given time: forward/back button, URL user selectable input field, favorites control, history control, search control, pull-down menu controls, standard button controls, address bar controls, folder controls, or any other control which, if enabled, would permit the user to access information or web pages beyond the initially loaded web page or beyond any links specified within the focused web page.

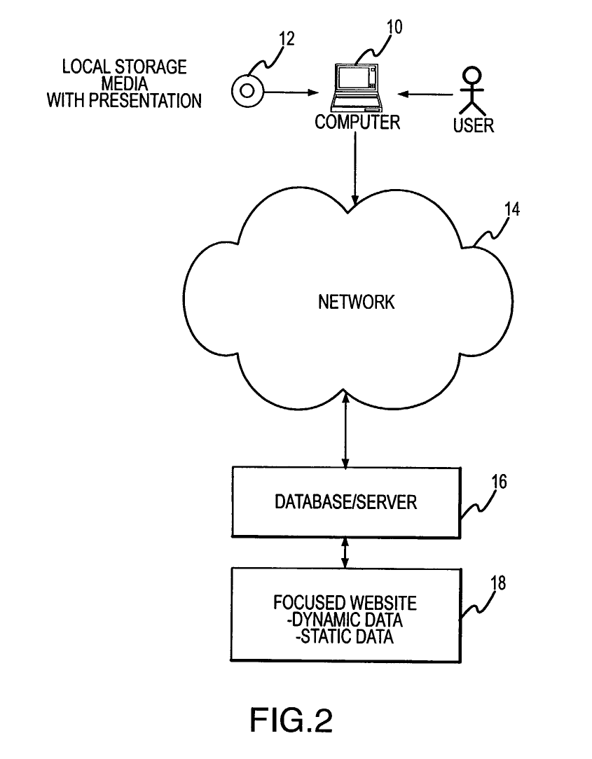

Referring to FIG. 2, a block diagram of one embodiment of the present invention is shown. In accordance with one embodiment of the present invention, a user at a computer 10 accesses a presentation, which in one example, is provided via a local storage media 12. The local storage media can take the form of a CDROM, standard sized or business card sized optical disk, or can take the form of any other storage media such as a disk, a memory card or memory stick, a custom-shaped CDROM, or any other persistent removable storage device, having a presentation thereon, either in compressed or uncompressed form.

As used herein, the term “presentation” includes, but is not limited to, a textual and in some cases graphical, video, and audio presentation of information, entertainment, traditional network links, jump stations, links to one or more focused websites, and other means by which to present information focused on a discrete subject matter or matters. For example, a presentation could be coded with Macromedia Flash™ technology, and be focused on marketing a particular real estate agent. Such a presentation could include a graphical or video presentation of various geographic areas the real estate agent services, or link to a site related to homes the real estate agent is representing for sale, a link to information about the agent, a textual description of contact information for the agent, and a jump station to a loan application. The myriad of potential presentations and the focus of such presentations is nearly limitless, and the broad aspects of the present invention are not intended to be limited to any particular presentation or method of coding such a presentation.

Referring again to FIG. 2, in one embodiment the user's computer 10 is coupled with a network 14, which in turn is coupled with a database/server 16 which is capable of hosting or providing access or links to a focused website 18. Upon the user initiating the presentation via the storage media 12 loaded locally on the user's computer 10, the user exercises the presentation and accesses various pieces of data and links of the presentation. In one example, the presentation is arranged in hierarchical form, so that the user follows a variety of links within the presentation. In accordance with one embodiment of the present invention, the presentation includes a link which provides the user the opportunity to access a focused website 18. This link which provides the user with the opportunity to view data from the focused website is referred to herein as a “jump station.”

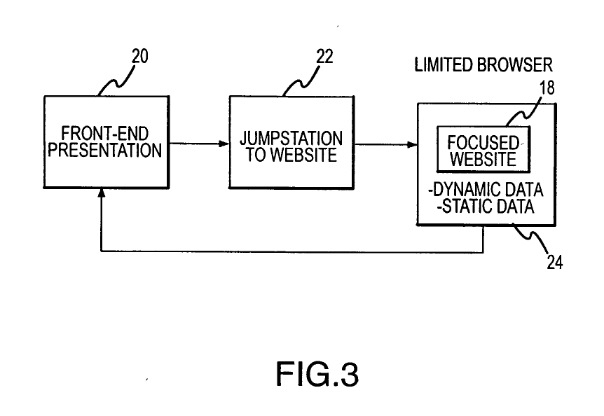

As used herein, a data link or “jump station” includes, but is not limited to, a means by which a user is controllably directed to static and/or dynamic focused information stored locally or non-locally. FIG. 3 illustrates a block diagram of one embodiment of the present invention. As shown in FIG. 3, a front end presentation 20 is provided which has a link to a jump station 22. The jump station provides a link to the focused website 18, and in one example, the focused website operates within a limited access browser 24. In operation, the user launches the front end presentation 20 and, upon activation/selection of a particular link within the presentation, the jump station 22 is accessed which provides access to or initiates/launches the limited access browser 24 with the focused website address provided. In one example, when the user has completed manipulating and reviewing the data within the focused website 18 (i.e., after the user has closed the limited access browser 24 window), control is returned to the front end presentation 20 and the user continues viewing the data or information provided within the presentation 20.

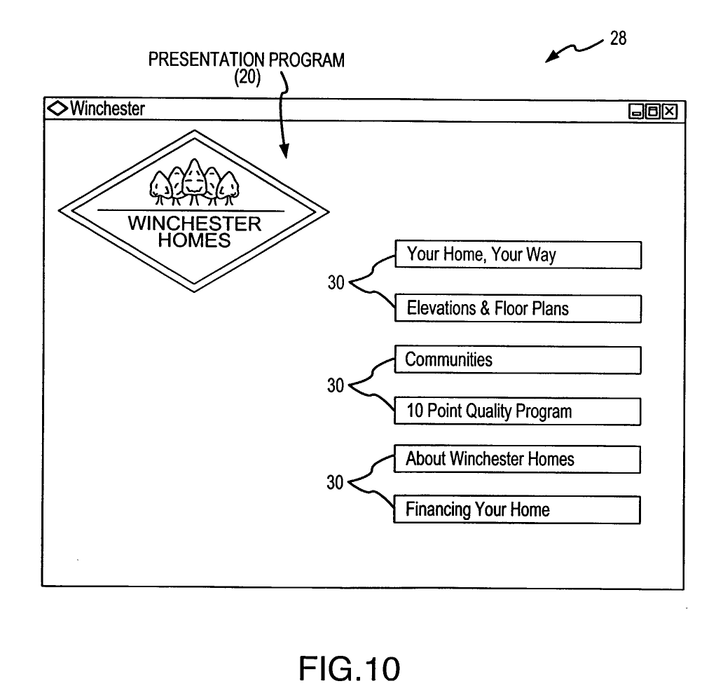

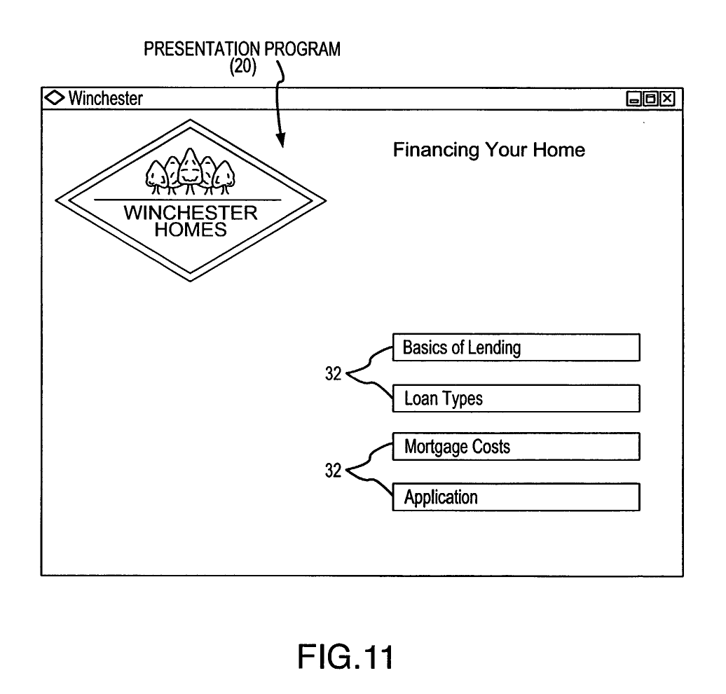

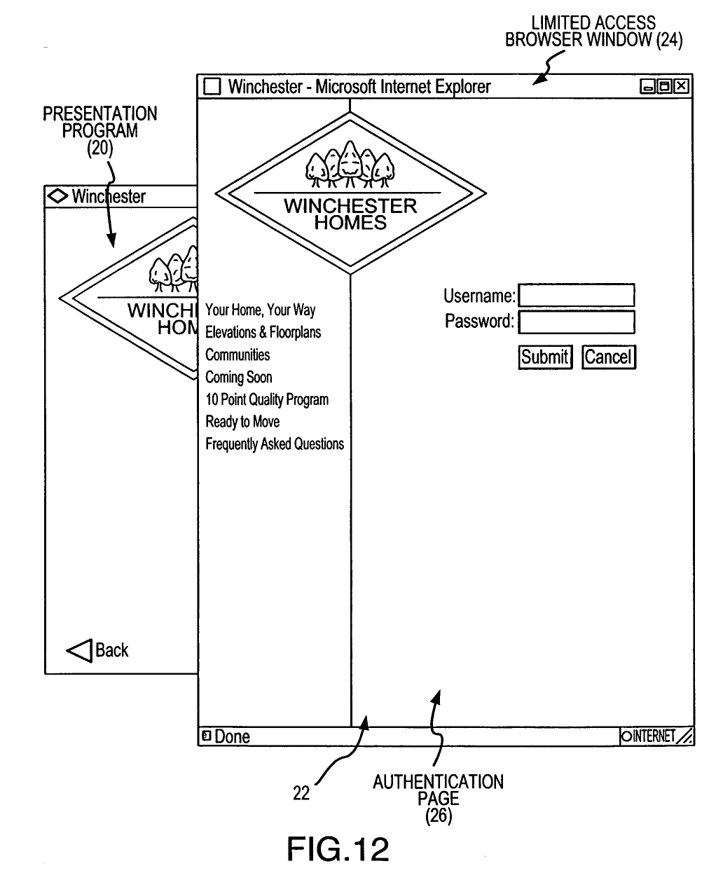

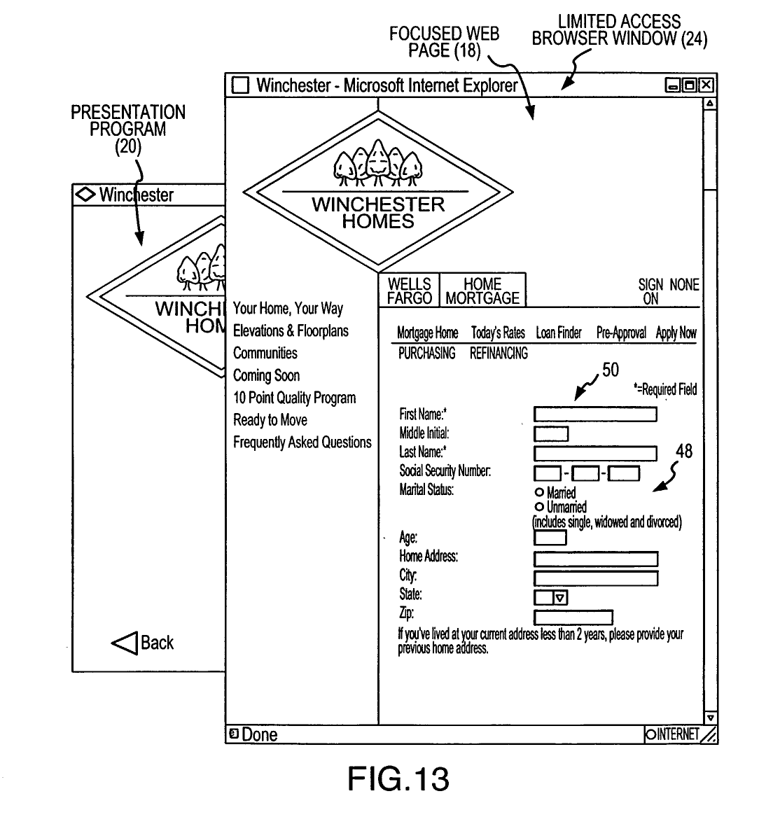

Various methods and operations for various embodiments of the present invention will now be described. Example display screens of one presentation are shown in FIGS. 10-11, while FIGS. 12-13 illustrate example display screens operating within a limited access browser window, in accordance with one embodiment of the present invention.

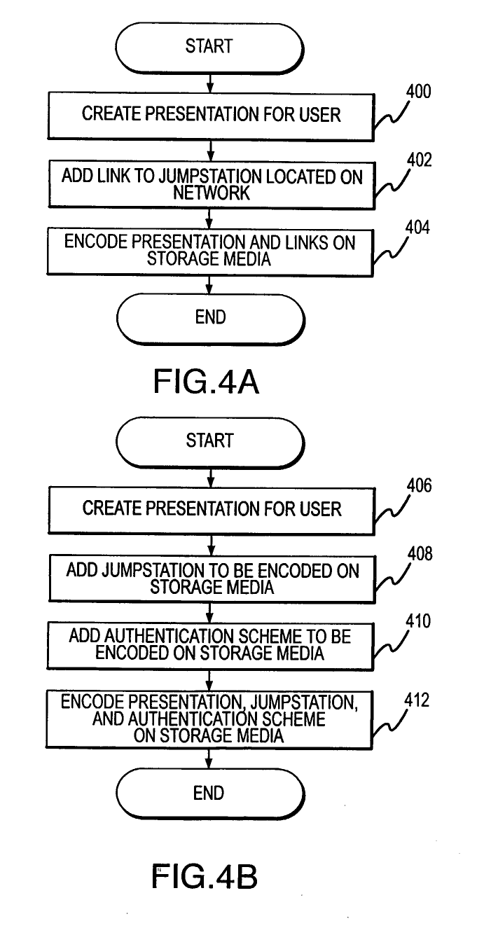

Referring to FIG. 4A, the logical operations for creating a presentation 20 on a storage media 12 are illustrated in accordance with one embodiment of the present invention. At operation 400, a presentation 20 is created for a user. In one example, the presentation is created specifically for a particular user, or for like individuals within a particular segment of industry or business. For instance, a presentation 20 could be created for the customers of a large technological parts manufacturer, customers of a particular real estate agent, potential buyers of homes built by a particular builder, etc. The presentation 20 includes, in one example, graphical, textual, audio, video, and any other form of data which may be suitable for making an effective presentation to the user. The presentation 20, in one example, is also arranged to include a hierarchical set of links, with particularized information arranged according to the various links.

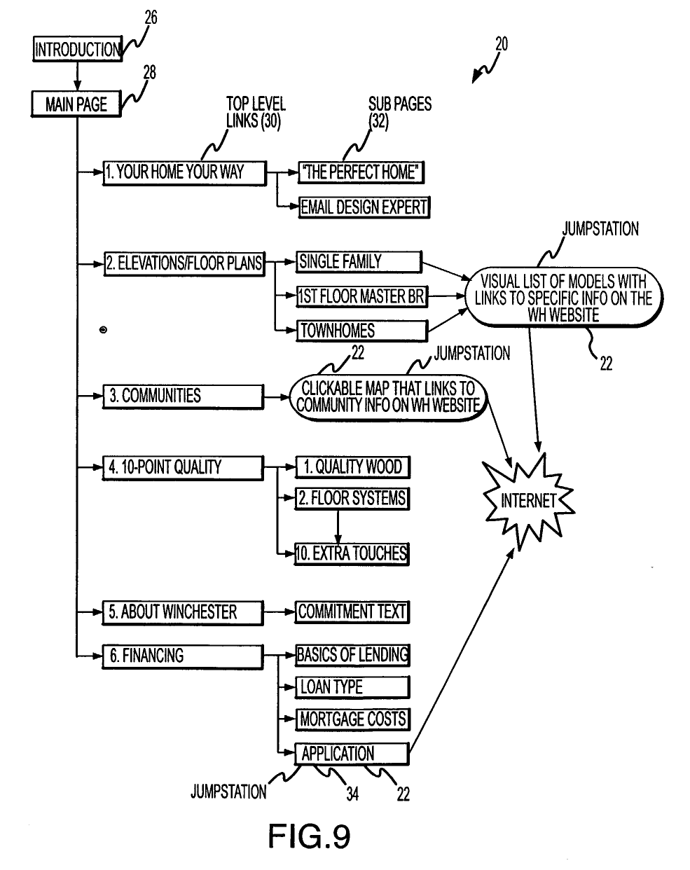

One example of the organization of a presentation 20 is illustrated in FIG. 9, wherein the presentation has an introduction 26, a main page 28, a plurality of top level links 30 and a plurality of sub-pages 32, which are displayed to the user upon the user selection of particular links within the hierarchy. As shown in FIG. 9, jump stations 22 can be provided within the hierarchy of the presentation. FIG. 9 illustrates three links to jump stations, and in particular shows an “Application” jump station 34, which in this example operates as a link to a financing application, which will be explained in greater detail below.

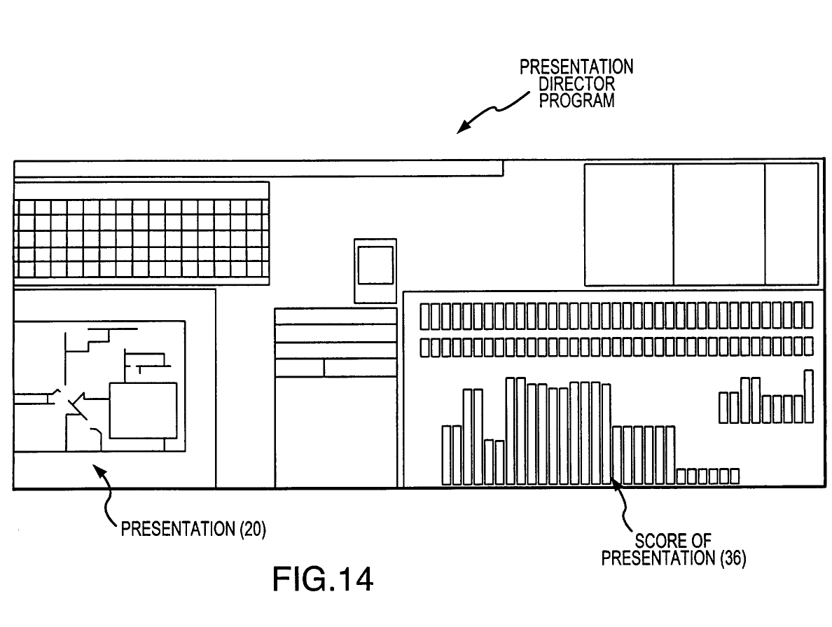

In one example, the presentation 20 is created using Macromedia's Director™ program, wherein a plurality of displays and controls are provided and arranged in a “score” of the presentation, as shown in one example in FIG. 14. While FIG. 14 illustrates an example of a presentation developed using a Macromedia™ product, it is understood that a presentation generally includes any presentation of data or information to a user.

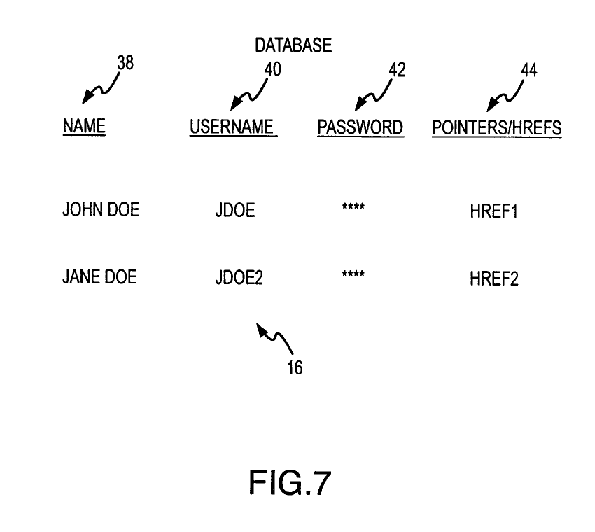

At operation 402 of FIG. 4A, a link to a jump station 22 is added to the presentation 20. In this example, the jump station is located on the network, as will be discussed with reference to FIG. 7. Operation 402 adds the link to the presentation such that when the presentation is running, if the user selects the jump station link therein, the presentation passes control to the jump station 22 located on the network. At operation 404, the presentation 20 and the links, including the link to the jump station 22, are encoded on the storage media 12. In this manner, the storage media 12 therefore includes, in this example, a presentation of data to a user, as well as a link to a jump station.

The jump station 22 can also be encoded on the storage media 12, as shown in the logical operations of FIG. 4B. At operation 406, the presentation 20 for a user is created, such as in operation 400 of FIG. 4A. In operation 408 of FIG. 4B, the jump station 22, including the link to it, are created so that they can be encoded on the storage media 12.

In operation 410, an authentication scheme is added to the presentation. In one example, the authentication scheme includes a password field. When the data link authentication exists on the storage media, it is possible to have a single authentication scheme for many individuals. In this case, for instance, the password field would be present and the data acquired from user input to that field would be compared to a predetermined password, stored securely within the presentation. If the user's input was deemed valid by comparing it to the predetermined password, the user would be allowed to access further data via the data link. If the user's input was deemed invalid by the previously noted comparison, the user would be directed to re-enter the password.

At operation 412, the presentation 20, the jump station 22, and the authentication scheme are encoded on the storage media. In the example of FIG. 4B, when the user activates a link to a jump station, the jump station runs based on the coding within the storage media, and then accesses the focused web pages from the jump station.

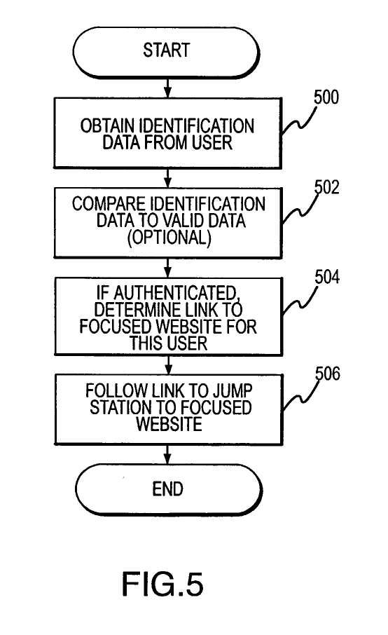

One example of the logical operations performed at the jump station 22 are illustrated in FIG. 5, in accordance with one example of the present invention. Generally, a jump station provides a “jump” or hop between a presentation 20 (which in one example is operating from a program obtained from a local storage media such as a CD-ROM) to a focused web page 18 having information and content which the user is provided the opportunity to access and review. In one example, the jump station 22 provides an authentication function which, based on user identification such as a user name, password, thumb print, voice scan, eye scan, or other verifiable user information, authenticates the user as the authorized user. Upon proper authentication, the jump station then provides the user with access to the focused website 18.

One advantage of encoding a presentation 20 with a link to jump station 22, and to a focused website 18 is that the presentation being encoded on a persistent storage media 12 will have static data primarily, but will be able to focus the user on dynamic data, i.e., data that can be modified and kept current, located at the focused website, such that the person or entity distributing the presentation can provide the user with current information at the focused website without having to distribute a new CDROM or the like.

In operation 500 of FIG. 5, identification data from the user is obtained. As previously mentioned, this data can include a user name, password, account number, purchase order number, thumb print, voice scan, eye scan, email address, or any other identification which, in some way, uniquely identifies the user, or identifies the user as a part of a group or segment of a group. For instance, identification data from the user could include merely the fact that the user is interested in purchasing a home in central Denver; that the user is a customer which has purchased a computer of a particular model type; that the user possesses a CDROM encoded with a presentation; or the like. Alternatively, the identification data could be specific to a particular user, such as a name and password, social security number, etc.

At operation 502, the identification data is compared to valid data. This operation is optional depending upon the particular implementation, but if included as part of the jump station, would include, for example, the comparison of the identification data to valid data stored in a database. FIG. 7 shows one example of a database 16 containing a name 38, user name 40, password 42, and pointers 44 known as “HREFs.” In the database example shown in FIG. 7, for each user, the pointers 44 provide an entry point into a focused website 18. Accordingly, as shown in the example, user John Doe has a pointer to HREF1, while user Jane Doe has a pointer to HREF2. If both John Doe and Jane Doe are properly authenticated, the jump stations for each user would point the respective user to different focused websites, in the example shown. Accordingly, the database configuration shown in FIG. 7 provides one example of how identification data can be used in a jump station to link a particular user, or a group or a class of users, to particular focused websites. By modifying the pointer 44, the person or entity that distributed the presentation can alter the focused website that the user is directed to when the jump station is selected. For example, to encourage viewing and use of the presentation, such as in a marketing or sales configuration, the pointer may be changed on a schedule, such as weekly, or randomly, to point the user to different focused websites. For instance, in a presentation configured for a travel agent, a focused website for particular tropical destinations may be linked to on a weekly basis, which would encourage the holder of the presentation to run it each week to learn about a new tropical destination. Upon each execution of the presentation, the user would also see information related to the travel agent.

Referring to operation 504 of FIG. 5, if the user is properly authenticated, operation 504 determines what link should be followed to the focused website for this user. As explained with reference to FIG. 7, for a particular user, one example would provide a one-to-one correlation between a user (38, 40) and a pointer 44 to the focused website. In one example, possession of the disc would equate to authentication (i.e., discs distributed within a company to specific individuals to whom the data is directed). In this example, the authenticated user is linked to the focused website by means of a direct link, encoded within the presentation. At operation 506, the link for the authenticated user to the focused website 18 is followed so that the focused website becomes accessible to the authenticated user, in this example.

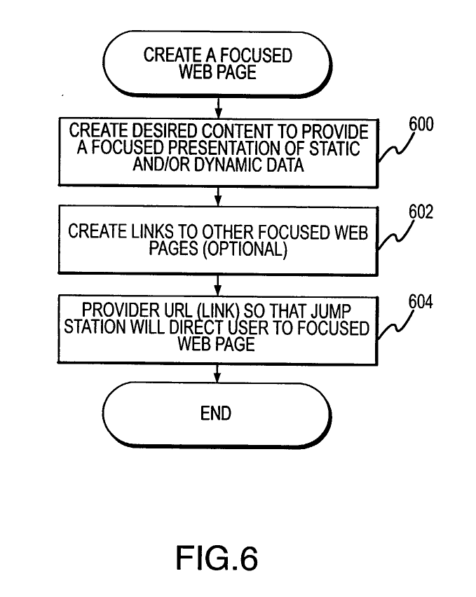

Having described the operations of a jump station, FIG. 6 illustrates the logical operations for creating a focused web page 18, in accordance with one embodiment of the present invention. At operation 600, the desired content to be provided as part of the focused web page is created. In one example, the desired content to be displayed within the focused web page contains static and/or dynamic data. In one example, the “look and feel” of the content or presentation of data within the focused web page is similar to the “look and feel” of the presentation, which provides the user with a seamless integrated presentation, that encompasses the focused website(s).

At operation 602, the focused web page 18 can optionally be provided with links to other focused web pages, or to other websites, as desired by the designer of the focused web page. In one example, however, the focused web page contains no links to any web page which is not a focused web page, thereby providing that the user cannot follow a link to a conventional web page which is not focused. At operation 604, the URL or link of the focused web page is provided or specified so that the jump station will direct the user to the focused web page. In one example, the URL of the focused web page is provided in forming the pointer/HREF 44 and stored within the database 16 corresponding to the users or group of users which should have access to the focused web page, from the jump station, as shown in FIG. 7.

One example of a focused web page or set of web pages, is web pages related to service alerts for a particular make and model of car. For example, a Ford™ Explorer™ presentation encoded on a CDROM, might include a jump station to a Ford™ Explorer™ service alert focused web page, which could be a page in a larger Ford™ specific set of pages addressing all types of instruction for all vehicle lines, where current service alerts are updated. In this manner, the user can quickly go to and receive the desired focused information without distraction or mis-navigation.

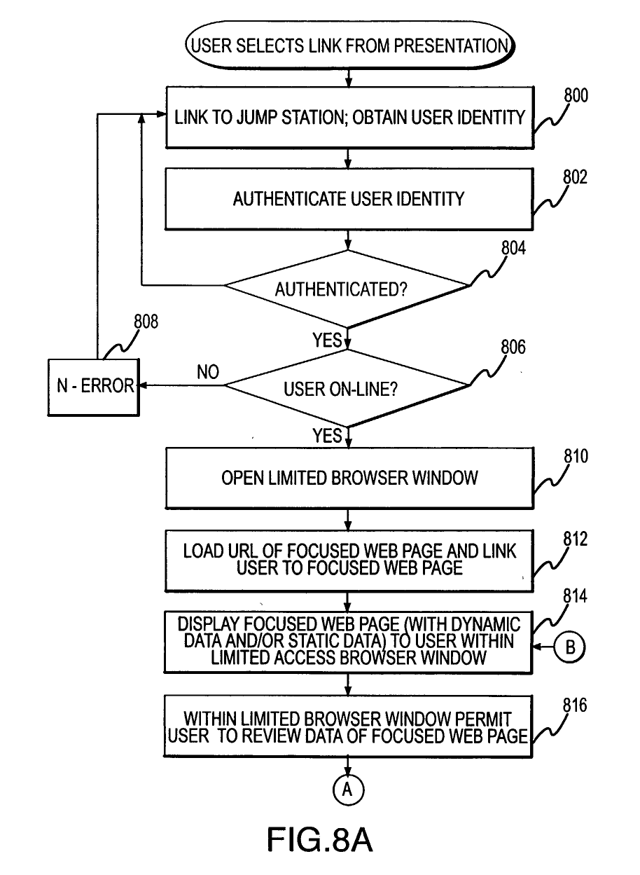

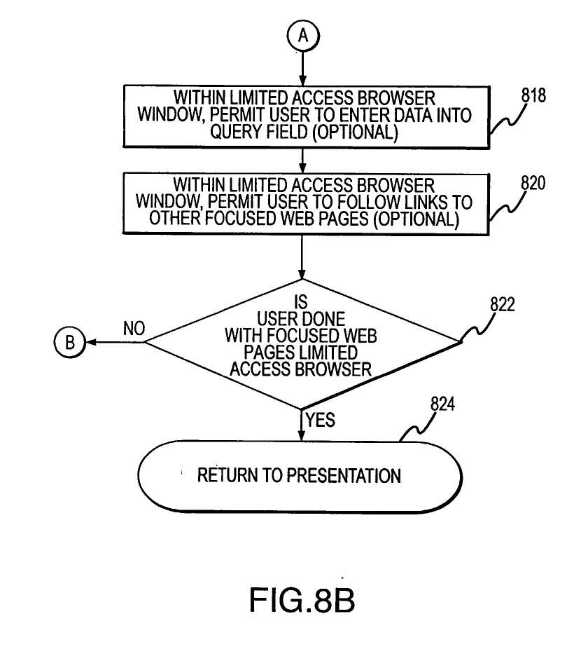

FIGS. 8A and 8B illustrate the logical operations of one embodiment of the present invention upon the user selecting a link from the presentation 20. At operation 800, if the selected link is a link to a jump station, then, in one example, the users identity or other identification information is provided. As previously described, this information can contain generally any data which identifies the user or identifies a grouping or class of users. At operation 802, in one example the user is authenticated, such as by:

If user is in database then

Go to “valid”

Else

Go to “invalid”

End if

At operation 804, if the authentication is successful, then control is passed to decision operation 806 such as by:

If “valid” then

Go to “online”

Else

Go to data link

End if

At decision operation 806, it is determined whether the user is presently online. Operation 806 determines whether the user is online so that the focused website 18 can be successfully accessed. In one example, decision operation 806 determines whether a particular text file is accessible at a particular URL page, and if so, then the user is online, but if not, the user is not online such as by.

GetNetText http://www.thehomedisc.com/testonline.txt

If error then user is not online

Go to “not online”

Else

Open browser

End if

If the user is not online, then control is passed on to operation 808, asking the user to enable an online connection to the network, and control is returned to operation 800, such as by:

If not online

Go to data link

End if

If the user is online, then at operation 810, the limited access browser 24 is opened. As explained above, in one example of the invention, a browser is opened with limited navigational abilities and controls such that the user is not able to access irrelevant or extraneous web pages. At operation 812, the URL of the focused web page 18 is loaded into the limited access browser window, and the limited access browser window is linked to the focused web page. At operation 814, the focused web page is displayed to the user within the limited access browser window. The focused web page includes static and/or dynamic data, and its contents is a matter of choice depending upon the particular implementation chosen. At operation 816, within the limited access browser window, the user is permitted to review the data of the focused web page.

In one example, operations 810-816 are implemented with the commands:

Go to URL http://www.the homedisc.com/destination.html

Browser=“no navigation, no address bar”.

Optionally, the user is queried for various pieces of data required for the functions implemented by the focused web page—such queries for data and such functions of the focused web page are a matter of choice depending upon the particular implementation.

Referring to FIG. 8B, at operation 818, within the limited access browser window, the user is permitted to enter data into the fields; this operation is optional. In one example, the user is permitted to enter data such as by:

If data entry field is present

Input data via keyboard

Store data in variable

POST data to web database or send via email

End if

The entry of data might be required in, for example, a loan application, such as is shown in FIG. 13. At operation 820, within the limited access browser window, the user is permitted to follow links to other focused web pages or web pages generally; this operation is optional. In one example, the user is permitted to follow links within focused browser such as by:

If link is present

On mouseUp of link

Go to URL associated with link, e.g., http://www.thehomedisc.com/destination2.html

End if

At decision operation 822, if the user is done with the focused web page within the limited access browser, then control is passed to the presentation. In one example, at operation 824, the limited access browser program is terminated, or minimized, depending upon the particular desired implementation. In one example, if the user is not done with the focused web page at decision operation 822, then control is returned to operation 814, such as by:

If call to close browser window (system level)

Close window (system level)

End if

FIGS. 10-13 illustrate an example of the display screens of a presentation 20 (FIGS. 10-11) and of a limited access browser 24 with a focused web page (FIGS. 12-13). FIG. 10 illustrates one example of a presentation program having a plurality of links 30 shown and arranged on a main page 28, while FIG. 11 illustrates sub-links 32 from FIG. 10 (assuming that the user selected the “financing you home” link from FIG. 10). FIG. 11 illustrates an “Application” link 34, which in this example, is a link to a jump station 22 shown in FIG. 12. The jump station 22, in this example, is an authentication page 46 provided within a limited access browser window 24. The authentication jump station 46 queries the user for a user name 40 and password 42. Upon entry of the proper user name and password, the jump station passes control to the focused web page 18 shown at FIG. 13, which in this example is a loan application 48 displayed within a limited access browser window 24. It can be seen in FIG. 13 that the limited access browser window 24 only permits the user to enter data into the data fields 50, but does not permit the user to generally access or “surf” the Internet.

In the example focused web page 18 shown in FIG. 13, a loan application 48, is shown having a plurality of data fields 50. The data fields 50 correspond with data needed for the loan application, such as the user's name, social security number, age, address, etc. Upon completion of the loan application 48, the user may submit the loan application.

In the presentation, main page 28, links 30, sub-links 32, jump station (22, 46), and focused web page (18, 48) shown in FIGS. 10-13, it can be seen that the user is presented with a focused presentation of static and dynamic data provided by way of a combination of information encoded in local storage media and information available at one or more focused web pages. For example, the presentation illustrated in FIG. 10 is encoded on a CDROM. The user, upon access of the presentation on the CDROM, is presented with the presentation shown in FIG. 10. The presentation is focused on the presenter, in this example a home builder. Each of the links in the presentation are related to the home builder's product. For example, there is a link to floor plans and there is a “Financing Your Home” link to a loan focused “Financing Your Home” sub-page (see FIG. 11).

The sub-page provides additional focused links “Basics of Lending,” “Loan Types,” and “Mortgage Costs,” which provide the user with pages of information related to each additional focused link topic. The sub-page also provides an application jump station 46 (see FIG. 12) to the authentication page 48 (see FIG. 13). If the user is authenticated, then the user is provided with access to an on-line loan application through a limited access browser 24. As can be seen, the presentation, links, sub-links, pages, jump stations, and focused web pages focus the user's attention on services related to the builder's business, i.e., building and selling homes.

When the user has completed entry and submission of the data, i.e., the dynamic data, queried of the user in the example focused web page of FIG. 13, control is returned to the presentation program, in one example. As shown in FIG. 9, other jump stations may be provided within the presentation that link the user to various other focused websites—such as a visual list of models of homes, or a map that links to a community information site. Of course, it is understood that the content of the focused web page or website is a matter of choice depending upon the particular implementation chosen. Further, it is understood that the content of the presentation is also a matter of choice dependent upon a particular implementation chosen.

According to another aspect of one embodiment of the present invention, the presentation 20 can be provided with variable or dynamic display fields which are transparently updated by a background process to reflect the current value obtained from a data source over the network. In this manner, the presentations can be designed to incorporate content which is seamlessly updated in a manner that is transparent to the user.

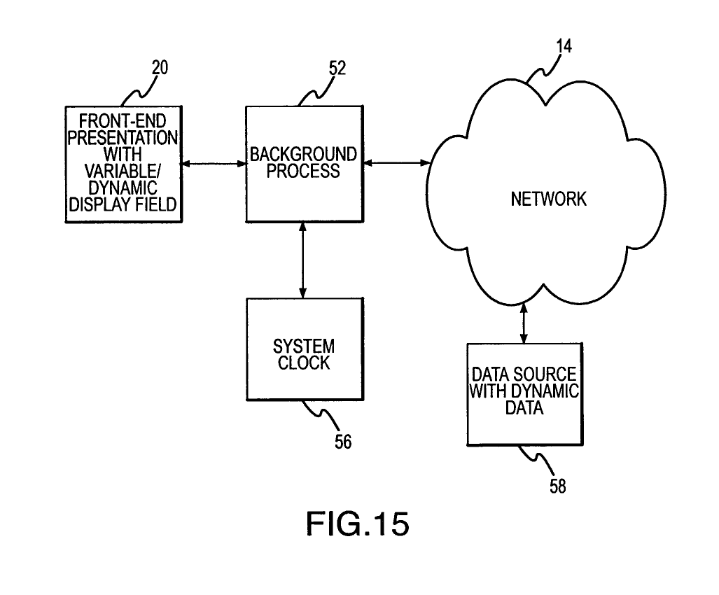

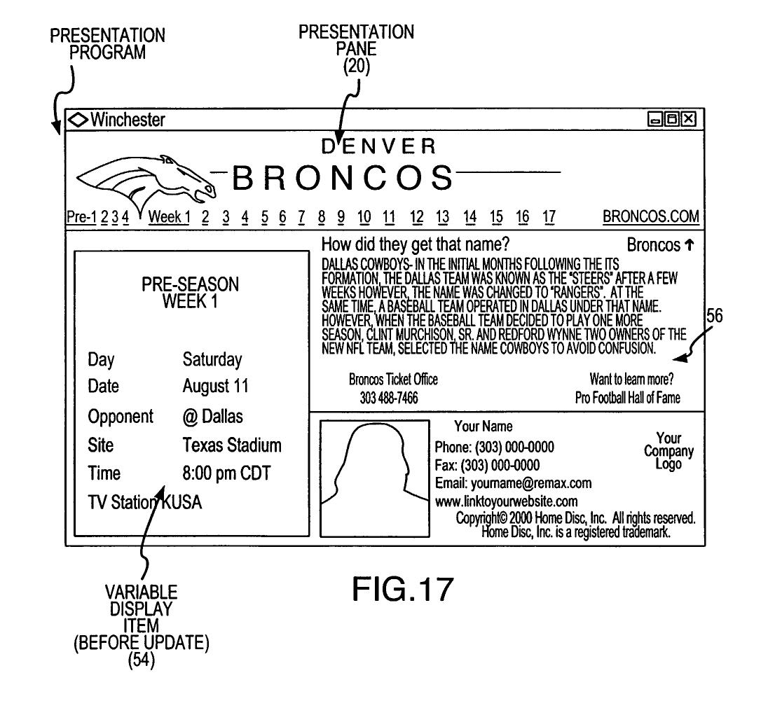

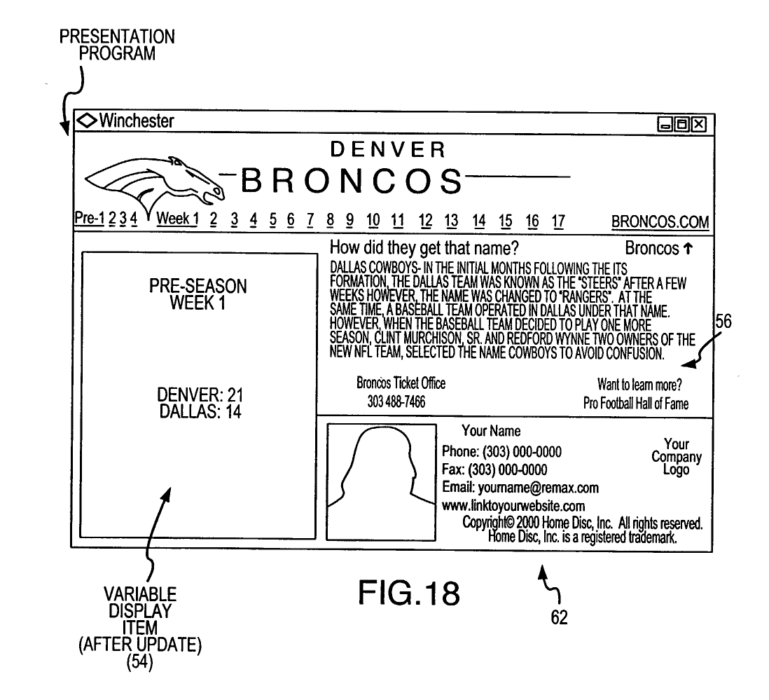

FIG. 15 illustrates a block diagram of one example of the present invention, wherein a background process 52 updates the variable and dynamic display fields of a presentation 20 with data obtained via the network 14. As shown in FIG. 15, a front end presentation 20 is provided with one or more display fields which display variable and/or dynamic data. For example, referring to FIG. 17, a presentation 20 is illustrated having a variable display item 54 contained therein. In the example of FIG. 17, the variable display item 54 is a block showing a football schedule for a particular time and date. FIG. 18 illustrates the same presentation program content wherein the variable display item 54 has been updated with the results of the score of the football game.

Referring again to FIG. 15, the background process 52 is responsible for obtaining updated data from the network 14 and providing the updated data to the presentation 20 for display therein. In one example, the background process 52 determines whether to access the network based upon the values provided by a system clock 56. For example, in the example display screens shown in FIG. 17-18, the background process 52 is programmed to seek updated data for the football schedule if the system clock 56 indicates that the time and date has passed a specified time and date (i.e., if the system clock is greater than 8:00 p.m. central time on August 11, in the example shown). The background process 52 is programmed so that it accesses a particular data source 58 over the network—for instance, the background process can have links to various websites or data sources on the network for obtaining particular pieces of information required by the presentation. The data source 58 can be updated at any time from a central location, in one example, thereby providing a means to provide dynamic data to the presentation without the need for actually encoding the presentation with new data.

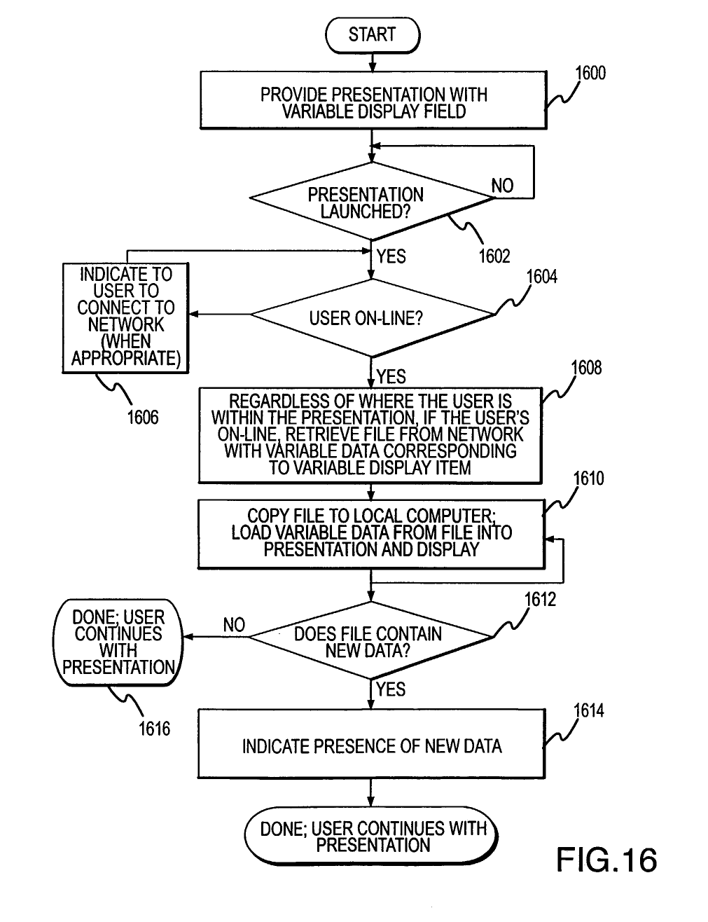

FIG. 16 illustrates one example of the logical operations for updating variable or dynamic display field data of a presentation with data from a network, in accordance with one embodiment of the present invention. In one example, the operations of FIG. 16 are generally performed after the presentation 20 is launched, irrespective of where the user is within the presentation—so that the update of the data within the presentation is transparent to the user.

At operation 1600 of FIG. 16, the presentation is provided with a variable display item to be displayed therein. For instance, the presentation can be encoded to include a display item 54 with a variable data field, or other item whose display is dependent upon variable data. Decision operation 1602 determines whether the presentation has been launched, and if so, control is passed to decision operation 1604. Decision operation 1604 determines whether the computer is presently online for instance, as explained above. If not, then operation 1606 indicates to the user that a connection to the network 14 is necessary. The indication of operation 1606 should be made when appropriate, such as when the user accesses a link which would require the display of the variable display item of operation 1600.

If the user is online, then at operation 1608 regardless of where the user is within the presentation 20, the variable data is obtained from the network. In one example, a file containing the variable data corresponding to the variable display item is retrieved from the network 14, such as by using the command:

“getnettext@http://www.website.com/data.txt.

This command retrieves the contents of the “data.txt” file from the network. At operation 1610, the contents of the file are copied to the local computer 10 (i.e., persistent memory), and the variable data is loaded from the file into the presentation 20 and displayed therein. So for instance, if the presentation has a variable display item of “the temperature in Denver” then upon retrieving current value of the temperature of Denver from the network, the value is then loaded into the presentation, and, depending upon the users interaction with the presentation, displayed at the appropriate time. At operation 1612, if the file contains new data, then operation 1614 indicates the presence of new data to the user (this operation is optional). For instance, if the presentation has an icon indicating updated information, then operation 1614 could activate the “updated information” icon so that the user is then made aware of the fact that there is new updated information to be viewed within the presentation. Upon indication of the presence of updated information, in operation 1618 the user proceeds with viewing the presentation. On the other hand, at operation 1616, if the file does not contain new data, then the user proceeds with the presentation.

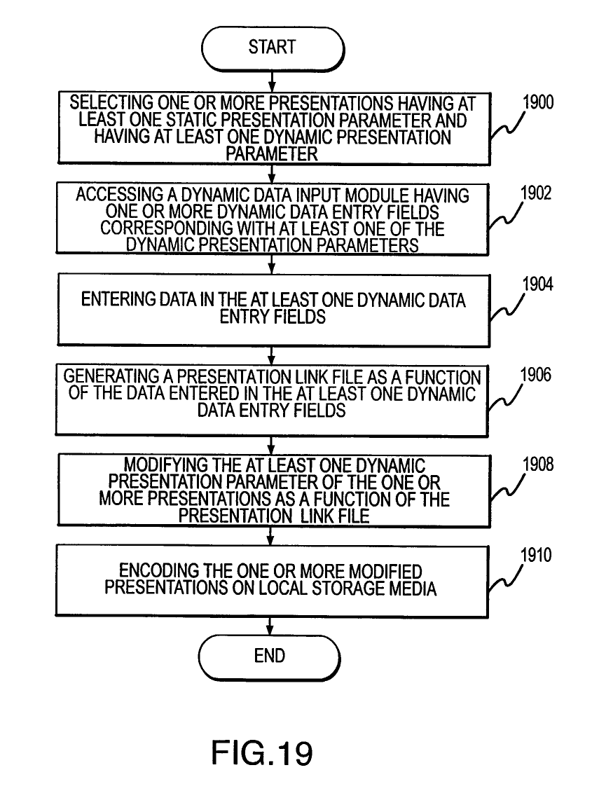

FIG. 19 illustrates the logical operation associated with a method of generating a presentation, in accordance with one embodiment of the present invention. A presentation developed for a particular presenter may have elements common to numerous potential different presenters. For example, the presentation shown in FIG. 17 includes a variable display item or field 54 related to a sporting event. The presentation also includes a second variable display item 60 related to the teams playing in the sporting event. In this case, the second variable display item 60 provides information regarding how the Dallas Cowboys were named. The second variable display item is provided from a background process 52 accessing a data source 58 having dynamic data. The background process 52 will receive a system clock 56 signal and access the data source 58 to update the second variable display 60. The variable display items are focused on a sporting team and accordingly provide focused information related thereto. Furthermore, the variable display items could be used by more than one user.

The presentation illustrated in FIG. 17 also includes a personal information section 62 having a name field, a phone number field, a fax number field, an e-mail address field, a company logo field, and a link to a company website. The personal information fields are unique to a single presenter unlike the variable display items. The presentation, with the exception of the contents of the personal information fields, could be used by anyone interested in providing a customized presentation, such as a CDROM based business card, which provides both their personal information and information related a sports team or event. Accordingly, embodiments of a presentation 20 can be provided in the form of a template with the static data being all of the information that is consistent between multiple persons or entities, and the dynamic data being all of the information customizable for a particular user or entity, such as the personal information fields 62.

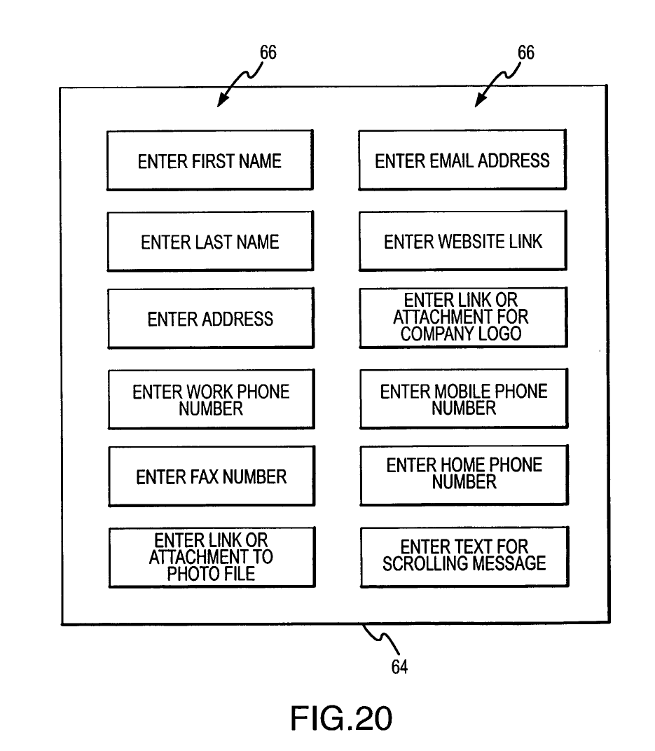

The personal information fields 62 are dynamic data fields that receive the input for the fields from a generator module. FIG. 20 illustrates a generator module 64 to allow a user to customize information for encoding in dynamic data fields of one or more presentations 20, in accordance with one embodiment of the present invention. To customize presentations for encoding on a local storage media, the generator module 64 allows a user to enter customized information for entry in dynamic data fields of a presentation. In the example generator illustrated in FIG. 20, a plurality of entry fields 66 are provided. The entry fields may have a one to one correspondence with the dynamic data fields of a single presentation, or may correspond with dynamic data fields for a plurality of presentations. In a generator embodiment having entry fields corresponding to dynamic data fields for a plurality of presentations, a single generator can be used to provide information to dynamic data fields in each presentation. In such a manner, the user enters information once for different presentations.

More particularly, the generator 64 shown in FIG. 20 includes a plurality of entry fields 66 such as a first name field, a last name field, an address field, a work phone number field, a fax number field, a photo field, a e-mail field, a website field, company logo field, a mobile phone number field, a home phone number field, and a scrolling message field. Some of the fields 66, such as the first and last name fields, require the user to provide the associated information, such as the first and last name that the user would like to have displayed in the personal information section 62 of the presentation 20 illustrated in FIG. 17. Other fields, such as the photo entry field, require the user to provide an attachment or a link to an attachment, such as a link to jpg file of the photo image that the user would like to have displayed in the personal information section 62 of the presentation 20 of FIG. 17.

Presentation templates, as with presentations, may be created with various software platforms such as Photoshop™, Illustrator™, Premier™, Director™, Flash™, and SoundForge™. The presentation templates may include dynamic data customizable by way of a generator module for any information desired. For example, a presentation template related to skiing may include a Flash™ presentation along with a Premier™ video presentation of a skier. The Flash™ presentation, may include dynamic personal information similar to the personal information shown in FIG. 17, and may also include a dynamic data scroll of various ski destinations. The user would customize the scrolling message field shown in FIG. 20 with ski destinations that they would like presented, e.g., Vail, Keystone, and Breckenridge. Another user might be interested in presenting ski destinations in Idaho, and would accordingly customize the scrolling message field with ski destinations in Idaho, such as Sun Valley.

The generator 64 illustrated in FIG. 20 includes entry fields that do not correspond with the presentation shown in FIG. 17. In some embodiments of the generator, entry fields are provided that correspond with several different presentation templates. Accordingly, a user could customize all of the presentations associated with the generator by entering data in the generator fields once. The presentation templates only utilize data from the entry fields that correspond with the particular presentation's dynamic data. For example, the presentation 20 of FIG. 17 would not use the scrolling message entry, but the skiing presentation template discussed above would.

Referring again to FIG. 19, at operation 1900, a user selects one or more presentations to customize. A myriad of customizable presentation templates having static data and dynamic data conforming to the present invention potentially exist, such as a golf presentation template having static data of a video graphic of a golfer taking a swing in a mountainous setting, a map of golf courses in a particular geographic area, a link to a jump station to golf courses having particular characteristics (e.g., 9 holes, 18 holes, less than $100 green fees, and greater than $100 green fees), and a dynamic personal information section. Generally, the static presentation data may be used by any person or entity interested in customizing the presentation. The dynamic data, on the other hand, is particular to a user, set of users, or an entity.

At operation 1902, a dynamic data input module, such as the generator module 64 shown in FIG. 20 is presented. The dynamic data input module includes one or more entry fields 68. As mentioned above, the entry fields correspond to the dynamic data fields in the one or more selected presentations. In the event that more than one presentation is selected, then, in one example, a single dynamic data input module is provided with entry fields pertaining to the dynamic data fields of all of the dynamic data fields. Accordingly, the user only has to provide input to entry fields 66 once in order to customize more than one presentation 20. At operation 1904, the user enters the information in the entry fields.

At operation 1906, a presentation link file is generated corresponding to the data inputted in the generator module 64. For example, if the first name “John” is entered in the “FIRST NAME” entry field of the generator 64, then the link file will include a “John” entry. At operation 1908, each selected presentation (from operation 1900) accesses the presentation link file, and updates the dynamic data fields. For example, if each presentation includes a first name dynamic data field, then the first name of “John” will be displayed in the corresponding location of the presentations.

By using the generator to customize a plurality of presentation templates, the user can quickly assess the desirability of each finished presentation and perhaps choose one or more of the selected and customized presentations for encoding on a local storage media. At operation 1910, upon selection of one or more finished presentations, the presentations are encoded on a local storage media.

Accordingly, it can be seen that embodiments of the present invention permit a user to quickly activate and access a presentation using, in one example, a local storage device with the presentation thereon. If the presentation requires the display of dynamic and/or static data on a website, embodiments of the present invention provide for a link to the network data to be displayed in a focused website using, in one example, a limited access browser. Further, if the presentation contains a variable display field, embodiments of the present invention provide that the variable display field can be transparently and automatically updated with current data information.

In addition to the various embodiments discussed above, it is envisioned that the invention described herein could be used in numerous other configurations. In one example, the invention is useful for mortgage businesses and real estate professionals that work with home buyers. The local storage media and presentation would include jump stations to focused websites providing answers to commonly asked mortgage and/or real estate questions. In this example, the local storage media is an authentication medium in itself. Possession of the local storage media is related to a particular real estate professional. Accordingly, the local storage media includes jump stations to focused websites for the particular real estate professional. The focused website might include, in one example, access to a focused website with information pertinent to the market in which the real estate agent works, e.g., information about local schools, information about local zoning, local shopping, etc. This is useful for assisting in relocating individuals. Using a process similar to that illustrated in FIGS. 15 and 16, a page illustrating current interest rates is provided, and includes an alert indicating when the interest rates have been changed.

The present invention is adaptable to include an application for a home purchase. In one example, the prospective borrower fills out an application form provided on the local storage media. The application data is then linked via a jump station to a focused website having a translator application accessible therefrom. The application data is translated by the translator, and the application is then submitted automatically to an underwriter. In one example, the translated application data is processed via the underwriter's application software. Accordingly, the application submission process is greatly simplified and streamlined. The applicant fills out the application and the application is automatically submitted with the underwriter.

In another example, the same process for applying for a new mortgage is used for refinancing. A local storage media encoded with a presentation and jump stations directed toward the retention of current holdings (mortgagors). Oftentimes, when the home market is in a refinancing boom, investors stand to lose millions if they do not provide their holdings (clients) with an attractive and motivating refinancing package, which may lead the client to refinance with an alternative lender.

In another example, the local storage media is encoded with a presentation and jump stations for a particular home builder. The jump stations would link the user to the builder's floor plans and the like. In addition, the jump stations would link the user to focused web pages for the particular user's home. In one example, the user would link to a focused web page displaying the status of the user's home under construction, e.g., the drywall is being installed. This example is equally applicable to loft builders in downtown areas. In another example, the builder provides a design tool for all aspects of designing (e.g., floor plans, carpet choices, tile choices, etc.) a new home. For example, a link to cabinets is provided, which links the user to a cabinet jump station, which in turn provides the user with a focused web page having the various cabinet choices the builder supports.

In another example, colleges and universities can use the present invention for marketing purposes as well as for capturing information needed from the students, e.g., applications and essays. The local storage media is encoded with an application for a particular university, upon filling in the appropriate data, a jump stations links the user to a focused web page for submitting the application to the university.

In another example, the present invention is useful for streamlining and simplifying convention organization. One or more local storage media are encoded with information regarding all things required to have an exhibit at the convention (electricity, booth space, chairs, tables, carpet, signage, hotels, dinning, etc.).

In yet another example, the present invention is utilized to provide travel information on specific travel packages. For example, the present invention is used to market and book a tour of South Africa. The local storage media includes video, audio and narration on each package offered as well as jump stations to focused websites for booking information for each trip.

Additional configurations are envisioned, including: providing targeted information related to specific needs of medical professionals; providing focused golf course information (e.g., address, phones, holes etc); providing focused cultural and educational event information (e.g., locations, costs, and times); providing focused training to employees; and providing interactive focused business cards; and providing the pre-listing documentation that a real estate agent needs to list a home for sale.

It can also be seen that presentations may be customized through the use of presentation templates and a generator module. The generator module having entry fields for dynamic data of the one or more presentation allow the user to enter the appropriate information area in an entry field of the generator, and have one or more presentations customized to reflect the information in the entry fields.

The embodiments of the invention described herein are implemented as logical operations in a computing system. The logical operations of the present invention are implemented (1) as a sequence of computing implemented steps running on the computing system and (2) as interconnected machine modules within the computing system. The implementation is a matter of choice dependent on the performance requirements of the computing system implementing the invention. Accordingly, the logical operations making up the embodiments of the invention described herein are referred to variously as operations, steps, or modules.

One or more of the above described computer implemented operations in another implementation of the present invention are provided as an article of manufacturer, i.e., a computer storage medium containing a computer program of instructions for performing the one of more of the above described steps.

While the methods disclosed herein have been described and shown with reference to particular operations or steps performed in a particular order, it will be understood that these operations or steps may be combined, sub-divided, or re-ordered to form an equivalent method without departing from the teachings of the present invention. Accordingly, the order and grouping of the steps is not generally intended to be a limitation of the present invention.

While the invention has been particularly shown and described with reference to particular embodiments, it will be understood by those skilled in the art that various other changes in the form and details may be made without departing from the spirit and scope of the invention.

We claim:

1. A method for directing a user to a focused network location, the method comprising:
providing a presentation encoded on a local storage media, the presentation comprising at least one link to at least one focused network location;
receiving a selection of the at least one link to the at least one focused network location;
opening a limited access browser window;
establishing a connection with the at least one focused network location; and
displaying the at least one focused network location within the limited browser access window.

2. The method of claim 1 wherein the at least one link to a focused network location comprises a jump station link to a jump station, and wherein the method further comprises:
receiving a selection of the jump station link;
accessing the jump station;
receiving an identification associated with the user; and
establishing a connection to the focused network location as a function of the identification associated with the user.

3. The method of claim 2 wherein the operation of accessing the jump station further comprising establishing a connection to the jump station, the jump station being located at a network address.

4. The method of claim 2 wherein the jump station is encoded on the local storage media.

5. The method of claim 2 further comprising:
accessing a database comprising at least one user authentication entry;
comparing the at least one user authentication entry with the identification associated with the user; and
establishing a connection with the focused network location as a function of the operation of comparing.

6. The method of claim 5 wherein the database further comprises at least one focused network location pointer associated with each at least one user authentication entry; and further comprising:
determining the at least one focused network location pointer associated with the at least one user authentication entry as a function of the operation of comparing; and
establishing a connection with the at least one focused network location associated with the least one focused network location pointer.

7. The method of claim 1 wherein the limited access browser window has at least one browser control disabled.

8. The method of claim 1 wherein the at least one focused network location includes a page associated with an intranet.

9. The method of claim 1 wherein the at least one focused network location includes a web page associated with the Internet.

10. The method of claim 1 wherein the presentation further comprises at least one variable display item, the method further comprising:
establishing a link with a computing element comprising update information for the variable display item;
receiving the update information; and
updating the variable display item as a function of the operation of receiving the update information.

11. The method of claim 10, the operation of establishing a link with a computing element further comprising accessing a memory location associated with the computing element, the computing element comprising a personal computing device.

12. The method of claim 10, the operation of establishing a link with a computing element further comprising accessing a network location associated with the computing element.

13. The method of claim 12 wherein the network location comprises a web page of the Internet.

14. The method of claim 1 wherein the presentation comprises information formats selected from the group consisting of text, graphics, images, video, audio, and links.

15. A computer-readable medium containing instructions which, when executed, perform the method of claim 1.

16. A method of providing focused information to a user comprising:
providing a presentation encoded on a local storage media, the presentation comprising at least one static information field and at least one dynamic information field;
accessing a site on a network comprising update information for the dynamic information field;
receiving the update information for the dynamic information field; and
updating the dynamic data information field with the update information.

17. The method of claim 16 further comprising:
displaying the presentation with the update information.

18. The method of claim 16 further comprising:
updating the site on the network with the update information.

19. The method of claim 16 wherein the presentation comprises information formats selected from the group consisting of text, graphics, images, video, audio, and links.

20. A computer-readable medium containing instructions which, when executed, perform the method of claim 16.

21. A method for generating a presentation comprising:
providing at least one presentation template comprising at least one dynamic data parameter;
providing a generator module comprising at least one entry field corresponding with the at least one dynamic data parameter;
receiving an input for the at least one entry field;
establishing a connection between the presentation template and the generator module; and
modifying the at least one dynamic data field as a function of the operation of receiving an input for the at least one entry field.

22. The method of claim 21 further comprising:
after the operation of modifying the at least one dynamic data field, encoding the presentation template on a local storage media.

23. The method of claim 21 wherein the dynamic data parameter comprises information formats selected from the group consisting of text, graphics, images, video, audio, and links.

24. The method of claim 21 wherein the presentation template comprises information formats selected from the group consisting of text, graphics, images, video, audio, and links.

25. A computer-readable medium containing instructions which, when executed, perform the method of claim 21.

26. An apparatus for providing focused information to a user comprising:
means for storing a presentation;
means for linking to a focused network location;
means for providing a limited access browser window;
means for establishing a connection to the focused network location; and
means for displaying the focused network location within the limited access browser window.
